(19) United States
(12) Patent Application Publication
(10) Pub. No.: US 2026/0067555 A1
(43) Pub. Date: Mar. 5, 2026

(54) SYSTEM AND METHOD FOR OPTICAL CHARACTER IDENTIFICATION ON CURVED PLANES

(71) Applicant: Nuvis Technologies Inc., Mississauga (CA)

(72) Inventors: Anton Goma Huguet, Cervera (ES); Damodar Arapakota, Mississauga (CA)

(73) Assignee: Nuvis Technologies Inc., Mississauga (CA)

(21) Appl. No.: 19/035,393

(22) Filed: Jan. 23, 2025

Related U.S. Application Data
(60) Provisional application No. 63/688,966, filed on Aug. 30, 2024.

(51) Int. Cl. H04N 23/61; G03B 43/00; H04N 23/51; H04N 23/52; H04N 23/56; H04N 23/63; H04N 23/65; H04N 23/661; H04N 25/60; H04N 25/705

(52) U.S. Cl. CPC H04N 23/61; G03B 43/00; H04N 23/51; H04N 23/52; H04N 23/56; H04N 23/632; H04N 23/65; H04N 23/661; H04N 25/60; H04N 25/705

(57) ABSTRACT

The various embodiments herein provide a system and method for character identification on curved planes. The system integrates advanced imaging techniques, standardized character positioning, and a multi-plane OCR module utilizing machine learning to accurately identify characters on non-planar surfaces, such as ship hulls or cylindrical containers. The system includes a surface adaptation module for mapping and adjusting to surface curvatures, ensuring high accuracy across diverse conditions. Real-time processing capabilities offer immediate recognition results, while continuous machine learning-driven improvement enhances the system's effectiveness over time. The system also features a robust communication module for seamless data integration with external applications and a durable housing design to ensure reliable operation in harsh environments. This comprehensive approach provides an efficient and adaptable solution for industries requiring precise OCR on curved surfaces.

### CROSS-REFERENCE TO RELATED APPLICATIONS

The embodiments herein claim the priority of the U.S. Provisional Patent Application filed on Aug. 30, 2024, with the Ser. No. 63/688,966 and titled, “SYSTEM AND METHOD FOR OPTICAL CHARACTER IDENTIFICATION ON CURVED PLANES”, the contents of which are incorporated herein by the way of reference.

### BACKGROUND

### Description of the Related Art

The embodiments herein are generally related to Optical Character Recognition (OCR) technologies. The embodiments herein are particularly related to a system and method for character identification on curved planes.

### Description of the Related Art

Traditional OCR systems are predominantly designed for flat, two-dimensional surfaces. These conventional systems struggle with the distortions introduced when characters are projected onto non-planar surfaces, resulting in significant inaccuracies during character recognition. For instance, identifying text on the hull of a ship or a cylindrical container often requires manual intervention to correct for the curvature-induced distortion, leading to inefficiencies and potential errors.

Existing methods have attempted to mitigate these challenges through manual calibration or specialized equipment, but these solutions are generally complex, time-consuming, and lack the robustness required for industrial applications. Moreover, they fail to provide consistent results across different types of curved surfaces, limiting their practical applicability.

Therefore, there exists a need for system and method for character identification on curved planes leveraging advanced imaging techniques, standardized character positioning, and machine learning to ensure precise character recognition on curved surfaces.

The abovementioned shortcomings, disadvantages and problems are addressed herein, which will be understood by reading and studying the following specification.

### OBJECT OF THE EMBODIMENTS HEREIN

The primary object of the embodiments herein is to provide a system and method for character identification on curved planes.

Another object of the embodiments herein is to enhance the accuracy of OCR on non-planar surfaces by employing a machine learning-based character recognition system.

Yet another object of the embodiments herein is to provide a system that standardizes character positioning to reduce distortion effects.

Yet another object of the embodiments herein is to enable the OCR system to adapt to various surface curvatures through surface mapping and adaptation.

Yet another object of the embodiments herein is to offer real-time processing capabilities for immediate character recognition and data output.

Yet another object of the embodiments herein is to continuously improve the OCR model's accuracy through machine learning techniques.

Yet another object of the embodiments herein is to ensure seamless integration of the OCR system with external industry-specific applications.

Yet another object of the embodiments herein is to provide a durable and stable housing system for the OCR components to withstand harsh industrial environments.

Yet another object of the embodiments herein is to maintain uninterrupted system operation through a robust power management system.

### SUMMARY

The following details present a simplified summary of the embodiments herein to provide a basic understanding of the several aspects of the embodiments herein. This summary is not an extensive overview of the embodiments herein. It is not intended to identify key/critical elements of the embodiments herein or to delineate the scope of the embodiments herein. Its sole purpose is to present the concepts of the embodiments herein in a simplified form as a prelude to the more detailed description that is presented later.

The other objects and advantages of the embodiments herein will become readily apparent from the following description taken in conjunction with the accompanying drawings.

The various embodiments herein provide a system and method for character identification on curved planes.

According to one embodiment herein, a system is provided for character identification on curved planes. The system comprises an Optical Imaging System capturing high-resolution images of characters on curved surfaces, ensuring that the images are of sufficient quality for further processing by the OCR module; a Character Positioning System standardizing the reading plane and aligning imaging system with the writing plane; a Multi-Plane OCR Module designed to recognize characters on surfaces with varying curvatures and orientation using a machine learning-based model, while handling the distortions due to curved surfaces; a Surface Adaptation Module mapping the three-dimensional characteristics of a surface, including curvatures and angles enabling accurate character recognition across a wide range of surface types and conditions; a Data Processing Unit carrying out preprocessing of the captured images, including noise reduction, contrast adjustment, and edge enhancement and preparing the images for accurate character recognition; a Machine Learning Training System managing diverse images of characters on curved surfaces for training purposes; a user interface allowing operators to configure the system, adjust parameters, fine tuning the system, and monitor performance, and displaying recognized characters and errors; a Communication Module configured for seamlessly transferring the recognized text data to external systems using a plurality of various communication protocols and an integration API that allows the OCR system to interface with industry-specific applications; a Power Management System providing a stable power supply and backup that activates during power outages, maintaining continuous operation and preventing data loss or system failure; and a Housing and Mounting System protecting the OCR components from environmental factors including moisture, dust, and physical impact and configured to secure the system to various surfaces, providing stability during operation and ensuring accurate performance in industrial settings. The Optical Imaging System further comprises a high-resolution camera capturing the images of characters on curved surfaces and an illumination module provides consistent lighting to reduce shadows and reflections which potentially distorts the captured images. The Character Positioning System further comprises a calibration mechanism ensuring that the camera and the multi-place character recognition module are correctly aligned with the standardized plane, thereby reducing distortion effects caused by the curvature of the surface. The user interface module further comprises a control panel for configuring system, adjusting parameters and monitoring the system performance, and a result display for viewing recognized characters, errors and alerts, enabling operators to make quick adjustments, and ensuring optimal performance in different environments. The housing and mounting system further comprises a protective casing made from durable materials withstanding harsh conditions, and a plurality of mounting brackets securing the system to various surfaces, providing stability during operation and ensuring accurate performance in industrial settings.

According to one embodiment herein, a method is provided for character identification on curved planes. The method includes: Capturing high-resolution images of characters on the curved surface under varying light conditions using the optical imaging system; Standardizing the positioning of the characters using specific markers or design features by the character positioning system and aligning the camera and multi-plane OCR module with the standardized plane of reading, reducing the variability in character positioning caused by the surface curvature; Surface Mapping and Adaptation mapping the three-dimensional characteristics of the surface, such as curvature and angles, and adapting the character recognition process by adjusting relevant parameters including the camera's focal length, the angle of illumination, and the settings of the distortion correction algorithm; Image preprocessing comprising noise reduction, contrast adjustment, and edge enhancement, improving image quality, making them suitable for accurate character detection and recognition; Detection and recognition of characters using machine learning-based model trained to handle various angles and orientations by multi-plane OCR module; Real-Time processing and generating Output wherein character recognition results are made available for further use in real-time by displaying on the user interface, along with associated confidence levels and any alerts or errors encountered during the recognition process; Continuous improvement through machine learning wherein the ML training module collects data on the performance of the OCR module, and retrains and refines the machine learning model, ensuring that it remains effective in recognizing characters across a wide range of scenarios and surface conditions enabling the system to adapt to new challenges and maintain high levels of accuracy over time; Transmitting data to external systems using a plurality of communication protocols, ensuring that the recognized text data can be accurately and efficiently integrated into existing workflows and seamlessly interfacing with industry-specific applications, enabling automated processes such as data entry, tracking, and monitoring using Application Programming Interface (API); and ensuring continuous and stable operations in the presence and absence of regular power supply and varying environmental conditions affected by a plurality of factors including moisture, dust and physical impacts. The method for Detecting and recognizing characters machine learning-based model trained to handle various angles and orientations by multi-plane OCR module includes detecting the presence and location of characters within the preprocessed images; recognizing the characters; refine the results by compensating for any remaining distortions caused by the curvature of the surface using the distortion correction algorithm, and ensuring that characters are accurately identified, even on complex surfaces.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The other objects, features and advantages will occur to those skilled in the art from the following description of the preferred embodiment and the accompanying drawings in which:

FIG. 1 illustrates the overall architecture of the system for character identification on curved planes, according to one embodiment herein.

FIG. 2 illustrates the method for character identification on curved planes, according to one embodiment herein.

Although the specific features of the embodiments herein are shown in some drawings and not in others. This is done for convenience only as each feature may be combined with any or all of the other features in accordance with the embodiment herein.

### DETAILED DESCRIPTION OF THE EMBODIMENTS HEREIN

In the following detailed description, a reference is made to the accompanying drawings that form a part hereof, and in which the specific embodiments that may be practiced is shown by way of illustration. These embodiments are described in sufficient detail to enable those skilled in the art to practice the embodiments and it is to be understood that other changes may be made without departing from the scope of the embodiments. The following detailed description is therefore not to be taken in a limiting sense.

The various embodiments herein provide a system and method for character identification on curved planes.

According to one embodiment herein, a system is provided for character identification on curved planes. The system comprises an Optical Imaging System capturing high-resolution images of characters on curved surfaces, ensuring that the images are of sufficient quality for further processing by the OCR module; a Character Positioning System standardizing the reading plane and aligning imaging system with the writing plane; a Multi-Plane OCR Module designed to recognize characters on surfaces with varying curvatures and orientation using a machine learning-based model, while handling the distortions due to curved surfaces; a Surface Adaptation Module mapping the three-dimensional characteristics of a surface, including curvatures and angles enabling accurate character recognition across a wide range of surface types and conditions; a Data Processing Unit carrying out preprocessing of the captured images, including noise reduction, contrast adjustment, and edge enhancement and preparing the images for accurate character recognition; a Machine Learning Training System managing diverse images of characters on curved surfaces for training purposes; a user interface allowing operators to configure the system, adjust parameters, fine tuning the system, and monitor performance, and displaying recognized characters and errors; a Communication Module configured for seamlessly transferring the recognized text data to external systems using a plurality of various communication protocols and an integration API that allows the OCR system to interface with industry-specific applications; a Power Management System providing a stable power supply and backup that activates during power outages, maintaining continuous operation and preventing data loss or system failure; and a Housing and Mounting System protecting the OCR components from environmental factors including moisture, dust, and physical impact and configured to secure the system to various surfaces, providing stability during operation and ensuring accurate performance in industrial settings

According to one embodiment herein, an Optical Imaging System is provided for capturing high-resolution images of characters on curved surfaces, ensuring that the images are of sufficient quality for further processing by the OCR module. The system further comprises a high-resolution camera capturing the images of characters on curved surfaces and an illumination module provides consistent lighting to reduce shadows and reflections which potentially distorts the captured images.

According to one embodiment herein, the Character Positioning System standardizes the reading plane using specific markers and embedded design features to create a reference plane that aligns the characters in a consistent manner. The system further comprises a calibration mechanism ensuring that the camera and the multi-place character recognition module are correctly aligned with the standardized plane, thereby reducing distortion effects caused by the curvature of the surface.

According to one embodiment herein, the Multi-Plane OCR Module is designed to recognize characters on surfaces various angles and orientations using a machine learning-based model trained to handle different angles and orientations, allowing it to accurately identify characters despite the distortions introduced by the curved surface. Additionally, this module is configured with a distortion correction algorithm dynamically adjusting the recognition process based on the specific characteristics of the surface being analyzed.

According to one embodiment herein, the Surface Adaptation Module maps the three-dimensional characteristics of the surface including its curvature and angles and adjusts the character reading process by modifying relevant parameters, ensuring that the system maintains high accuracy across a wide range of surface curvatures and texture.

According to one embodiment herein, the Data Processing Unit carries out preprocessing of captured images, which includes noise reduction, contrast adjustment, and edge enhancement for improved character recognition and wherein the data processing unit enables real-time character reading for applications requiring rapid character identification like identifying vehicle registration or ship hull ID.

According to one embodiment herein, the Machine Learning Training System manages a diverse dataset of images from various curved surfaces for training purposes and uses this data to retrain the character recognition model, ensuring that it remains effective in recognizing characters across different scenarios and wherein the Machine Learning Training System The ensure that only the most accurate and reliable models are used in the system by model training and validation processes.

According to one embodiment herein, the User Interface provides operators with an intuitive platform to interact with the OCR system. The user interface further comprises a control panel for configuring system, adjusting parameters and monitoring the system performance, and a result display for viewing recognized characters, errors and alerts, enabling operators to make quick adjustments, and ensuring optimal performance in different environments.

According to one embodiment herein, the Communication Module provides a data transmission interface that seamless transfers recognized text data to external systems. The module is configured to support a plurality of communication protocols and includes an integration API allowing the OCR system to connect with industry-specific applications, enabling the automation of data entry, tracking, and monitoring processes.

According to one embodiment herein, the Power Management System ensures the reliable operation of the OCR system by providing a stable power supply. This system further comprises a battery backup that activates during power outages, maintaining continuous operation and preventing data loss or system failure and wherein the power management system is designed for energy-efficiency, reducing overall power consumption while maintaining high performance.

According to one embodiment herein, the Housing and Mounting System protects the OCR components from environmental factors including moisture, dust, and physical impact and wherein the system further comprises a protective casing made from durable materials withstanding harsh conditions, and ensuring the longevity of the system; and a plurality of mounting brackets securing the system to various surfaces, providing stability during operation and ensuring accurate performance in industrial settings.

According to one embodiment herein, a method is provided for character identification on curved planes. The method includes: Capturing high-resolution images of characters on the curved surface under varying light conditions using the optical imaging system; Standardizing the positioning of the characters using specific markers or design features by the character positioning system and aligning the camera and multi-plane OCR module with the standardized plane of reading, reducing the variability in character positioning caused by the surface curvature; Surface Mapping and Adaptation mapping the three-dimensional characteristics of the surface, such as curvature and angles, and adapting the character recognition process by adjusting relevant parameters including the camera's focal length, the angle of illumination, and the settings of the distortion correction algorithm; Image preprocessing comprising noise reduction, contrast adjustment, and edge enhancement, improving image quality, making them suitable for accurate character detection and recognition; Detection and recognition of characters using machine learning-based model trained to handle various angles and orientations by multi-plane OCR module; Real-Time processing and generating Output wherein character recognition results are made available for further use in real-time by displaying on the user interface, along with associated confidence levels and any alerts or errors encountered during the recognition process; Continuous improvement through machine learning wherein the ML training module collects data on the performance of the OCR module, and retrains and refines the machine learning model, ensuring that it remains effective in recognizing characters across a wide range of scenarios and surface conditions enabling the system to adapt to new challenges and maintain high levels of accuracy over time; Transmitting data to external systems using a plurality of communication protocols, ensuring that the recognized text data can be accurately and efficiently integrated into existing workflows and seamlessly interfacing with industry-specific applications, enabling automated processes such as data entry, tracking, and monitoring using Application Programming Interface (API); and ensuring continuous and stable operations in the presence and absence of regular power supply and varying environmental conditions affected by a plurality of factors including moisture, dust and physical impacts.

According to one embodiment herein, Surface Mapping and Adaptation process maps the three-dimensional characteristics of the surface, such as curvature and angles. and adapts the character recognition process by adjusting relevant parameters, including the camera's focal length, the angle of illumination, and the settings of the distortion correction algorithm. ensuring that the system can effectively handle different types of curved surfaces, and maintaining high accuracy in character recognition

According to one embodiment herein, the Image Preprocessing process carries out a plurality of steps including noise reduction, contrast adjustment, and edge enhancement, for improving image quality, ensuring that the images are clean and sharp, making them suitable for accurate character detection and recognition by the multi-plane OCR module.

According to one embodiment herein, the method for Detecting and recognizing characters machine learning-based model trained to handle various angles and orientations by multi-plane OCR module includes detecting the presence and location of characters within the preprocessed images; recognizing the characters; refine the results by compensating for any remaining distortions caused by the curvature of the surface using the distortion correction algorithm, and ensuring that characters are accurately identified, even on complex surfaces.

According to one embodiment herein, a system is provided for optical character identification on curved planes. The system comprises: an optical imaging system configured to capture high-resolution images of characters on curved surfaces under varying light conditions, providing suitable image quality for further processing; a character positioning system configured to standardize the reading plane and align the imaging system with the writing plane; a surface adaptation module configured to map three-dimensional characteristics of a surface and dynamically adjust recognition parameters to improve character identification accuracy; a multi-plane OCR module configured to recognize characters on curved surfaces using a machine learning-based model trained to handle distortions and a plurality of orientations; a data processing unit configured to preprocess captured images to improve recognition accuracy; a machine learning training module; a user interface module configured to allow configuration, performance monitoring, and real-time display of recognized characters and errors; a communication module; a power management system configured to provide stable power supply and backup for continuous operation during power outages; and a housing and mounting system configured to protect the system components from environmental factors and secure the system on a plurality of surfaces for stable operation.

According to one embodiment herein, the optical imaging system further comprises a high-resolution camera for capturing images of characters on curved surfaces and an illumination module providing consistent lighting to reduce shadows and reflections.

According to one embodiment herein, the character positioning system includes a calibration mechanism for aligning the camera and OCR module with a standardized reading plane, minimizing distortions caused by surface curvature.

According to one embodiment herein the surface adaptation module maps surface characteristics such as curvature, angles, and texture and dynamically adjusts camera focal length, illumination angle, and distortion correction settings.

According to one embodiment herein, the multi-plane OCR module employs a distortion correction algorithm and is trained to recognize characters across varying curvatures and orientations, providing a high accuracy on complex surfaces.

According to one embodiment herein, the data processing unit is configured to perform image preprocessing, including noise reduction, contrast adjustment, and edge enhancement, to prepare images for accurate OCR.

According to one embodiment herein, the machine learning training module is configured to collect and utilize performance data to refine the OCR model, enabling adaptability to new surface conditions and improving accuracy over time.

According to one embodiment herein, the user interface module further includes: a control panel for configuring system parameters and monitoring system performance, and a display for real-time visualization of recognized characters, confidence levels, and alerts.

According to one embodiment herein, the communication module enables data transmission through wired or wireless protocols and integrates with a plurality of external applications using suitable APIs.

According to one embodiment herein, the housing and mounting system further comprises a durable casing to protect components from moisture, dust, and physical impact, and a plurality of mounting brackets to stabilize the system on industrial surfaces during operation.

According to one embodiment herein, a method is provided for optical character identification on curved planes, the method comprising: capturing high-resolution images of characters on a curved surface using an optical imaging system; standardizing the positioning of characters using a character positioning system to align the imaging system with a standardized reading plane; mapping three-dimensional characteristics of the surface using a surface adaptation module and dynamically adjusting parameters for character recognition; preprocessing the captured images using a data processing unit to reduce noise, adjust contrast, and enhance edges for improved OCR accuracy; detecting and recognizing characters using a multi-plane OCR module configured with a machine learning-based model to handle surface curvature and orientation distortions; generating real-time output of recognized characters and displaying results on a user interface module; continuously improving the OCR model using data collected by a machine learning training module to adapt to new surface conditions; and, transmitting recognized text data to external systems using a communication module.

According to one embodiment herein, the step of capturing high-resolution images includes utilizing the optical imaging system's illumination module to ensure consistent lighting and reduce distortions from shadows and reflections.

According to one embodiment herein, the step of standardizing character positioning includes using specific markers or calibration mechanisms in the character positioning system to align the imaging system with the standardized reading plane.

According to one embodiment herein, the step of mapping surface characteristics includes dynamically adjusting parameters, including camera focal length, illumination angle, and OCR algorithm settings, based on data from the surface adaptation module.

According to one embodiment herein, the preprocessing step includes enhancing image quality to improve OCR accuracy using noise reduction, contrast adjustment, and edge enhancement performed by the data processing unit.

According to one embodiment herein, the step of recognizing characters includes compensating for distortions caused by surface curvature using the multi-plane OCR module's distortion correction algorithm.

According to one embodiment herein, the real-time output generation step includes displaying recognized characters, confidence levels, and alerts on the user interface module.

According to one embodiment herein the continuous improvement step includes collecting performance data from the OCR module and refining the machine learning model using the machine learning training module.

According to one embodiment herein, the step of transmitting data includes using the communication module to send recognized text to external systems via APIs and communication protocols.

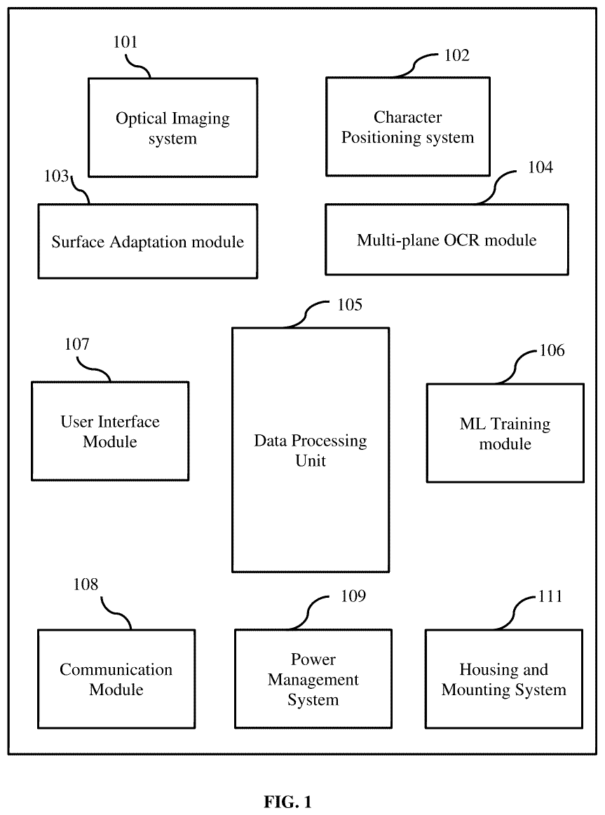

FIG. 1 illustrates the overall architecture of the system for character identification on curved planes, according to one embodiment herein. The system comprises: Optical Imaging System 101; Character Positioning System 102; Surface Adaptation Module 103; Multi-plane OCR Module 104; Data Processing Unit 105; ML Training Module 106; User Interface Module 107; Communication Module 108; Power Management System 109; and Housing and Mounting System 110.

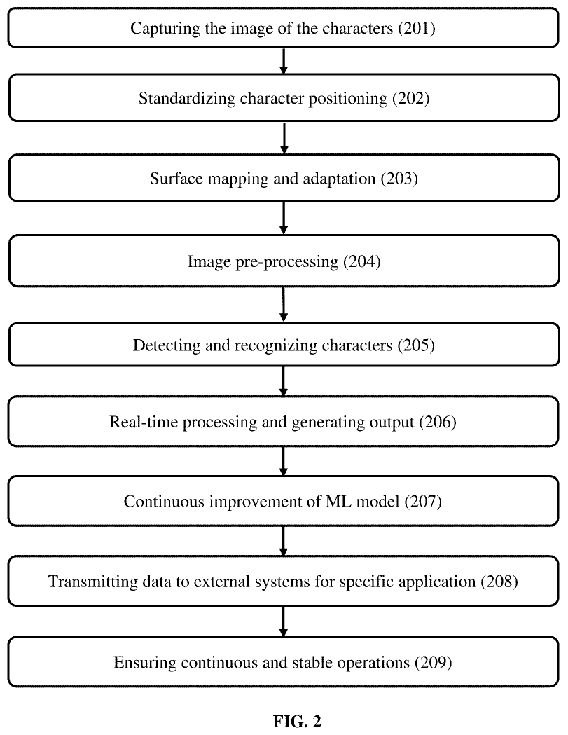

FIG. 2 illustrates the method for character identification on curved planes. The method includes: Capturing the image of the characters (201); Standardizing character positioning (202); Surface mapping and adaptation (203); Image pre-processing (204); Detecting and recognizing characters (205); Real-time processing and generating output (206); Continuous improvement of ML model (207); Transmitting data to external systems for specific application (208); and Ensuring continuous and stable operations (209).

The various embodiments herein provide a system and method for character identification on curved planes offering several distinct advantages over conventional traditional methods.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

It is also to be understood that the following claims are intended to cover all of the generic and specific features of the embodiments described herein and all the statements of the scope of the embodiments which as a matter of language might be said to fall there between.

What is claimed is:

1. A system for optical character identification on curved planes, the system comprising:
an optical imaging system configured to capture high-resolution images of characters on curved surfaces under varying light conditions, providing suitable image quality for further processing;
a character positioning system configured to standardize the reading plane and align the imaging system with the writing plane;
a surface adaptation module configured to map three-dimensional characteristics of a surface and dynamically adjust recognition parameters to improve character identification accuracy;
a multi-plane OCR module configured to recognize characters on curved surfaces using a machine learning-based model trained to handle distortions and a plurality of orientations;
a data processing unit configured to preprocess captured images to improve recognition accuracy;
a machine learning training module;
a user interface module configured to allow configuration, performance monitoring, and real-time display of recognized characters and errors;
a communication module;
a power management system configured to provide stable power supply and backup for continuous operation during power outages; and
a housing and mounting system configured to protect the system components from environmental factors and secure the system on a plurality of surfaces for stable operation.

2. The system according to claim 1, wherein the optical imaging system further comprises a high-resolution camera for capturing images of characters on curved surfaces and an illumination module providing consistent lighting to reduce shadows and reflections.

3. The system according to claim 1, wherein the character positioning system includes a calibration mechanism for aligning the camera and OCR module with a standardized reading plane, minimizing distortions caused by surface curvature.

4. The system according to claim 1, wherein the surface adaptation module maps surface characteristics such as curvature, angles, and texture and dynamically adjusts camera focal length, illumination angle, and distortion correction settings.

5. The system according to claim 1, wherein the multi-plane OCR module employs a distortion correction algorithm and is trained to recognize characters across varying curvatures and orientations, providing a high accuracy on complex surfaces.

6. The system according to claim 1, wherein the data processing unit is configured to perform image preprocessing, including noise reduction, contrast adjustment, and edge enhancement, to prepare images for accurate OCR.

7. The system according to claim 1, wherein the machine learning training module is configured to collect and utilize performance data to refine the OCR model, enabling adaptability to new surface conditions and improving accuracy over time.

8. The system according to claim 1, wherein the user interface module further includes: a control panel for configuring system parameters and monitoring system performance, and a display for real-time visualization of recognized characters, confidence levels, and alerts.

9. The system according to claim 1, wherein the communication module enables data transmission through wired or wireless protocols and integrates with a plurality of external applications using suitable APIs.

10. The system according to claim 1, wherein the housing and mounting system further comprises a durable casing to protect components from moisture, dust, and physical impact, and a plurality of mounting brackets to stabilize the system on industrial surfaces during operation.

11. A method for optical character identification on curved planes, the method comprising:
capturing high-resolution images of characters on a curved surface using an optical imaging system;
standardizing the positioning of characters using a character positioning system to align the imaging system with a standardized reading plane;
mapping three-dimensional characteristics of the surface using a surface adaptation module and dynamically adjusting parameters for character recognition;
preprocessing the captured images using a data processing unit to reduce noise, adjust contrast, and enhance edges for improved OCR accuracy;
detecting and recognizing characters using a multi-plane OCR module configured with a machine learning-based model to handle surface curvature and orientation distortions;
generating real-time output of recognized characters and displaying results on a user interface module;
continuously improving the OCR model using data collected by a machine learning training module to adapt to new surface conditions; and,
transmitting recognized text data to external systems using a communication module.

12. The method according to claim 11, wherein the step of capturing high-resolution images includes utilizing the optical imaging system's illumination module to ensure consistent lighting and reduce distortions from shadows and reflections.

13. The method according to claim 11, wherein the step of standardizing character positioning includes using specific markers or calibration mechanisms in the character positioning system to align the imaging system with the standardized reading plane.

14. The method according to claim 11, wherein the step of mapping surface characteristics includes dynamically adjusting parameters, including camera focal length, illumination angle, and OCR algorithm settings, based on data from the surface adaptation module.

15. The method according to claim 11, wherein the preprocessing step includes enhancing image quality to improve OCR accuracy using noise reduction, contrast adjustment, and edge enhancement performed by the data processing unit.

16. The method according to claim 11, wherein the step of recognizing characters includes compensating for distortions caused by surface curvature using the multi-plane OCR module's distortion correction algorithm.

17. The method according to claim 11, wherein the real-time output generation step includes displaying recognized characters, confidence levels, and alerts on the user interface module.

18. The method according to claim 11, wherein the continuous improvement step includes collecting performance data from the OCR module and refining the machine learning model using the machine learning training module.

19. The method according to claim 11, wherein the step of transmitting data includes using the communication module to send recognized text to external systems via APIs and communication protocols.
